(19) United States
(12) Patent Application Publication
(10) Pub. No.: US 2011/0290056 A1
(43) Pub. Date: Dec. 1, 2011

(54) Locking/Unlocking Device

(76) Inventors: Joaquin GARUZ RODES, Barcelona (ES); Francisco Javier FERNANDEZ QUIROS, Barcelona (ES)

(21) Appl. No.: 13/043,002

(22) Filed: Mar. 8, 2011

(30) Foreign Application Priority Data
May 26, 2010 (ES) U201030525

(51) Int. Cl. F16H 61/02; F16H 61/18

(52) U.S. Cl. 74/473.12

(57) ABSTRACT

A locking/unlocking device, specifically for locking and unlocking the reverse gear of the gearbox of a vehicle, comprising a housing provided interiorly with a fixed core provided with a coil and a mobile core triggered by the activation of said coil and attached to a computer by electrical connection means and a cam that is part of the gearbox, whose device comprises, in addition, a reverse gear position detector mechanism that is associated to the mobile core, said detector mechanism being provided with a stationary hall sensor and electromagnet inside the housing that operate via the presence of a metallic member arranged in the mobile core, such that depending on the position of the mobile core in relation to the fixed core, the hall sensor sends a signal to the computer to activate or lock the reverse gear condition.

### OBJECT OF THE INVENTION

The present invention is related to a locking/unlocking device that incorporates significant innovations and advantages.

More specifically, the invention proposes developing a reliable device that can be applied to a gearbox of a motor vehicle performing a dual function; one is a mechanical locking and unlocking function of the reverse gear position and the other function is to detect this when it is activated by providing a sensor.

### BACKGROUND OF THE INVENTION

The use of devices attached to a gearbox of a vehicle, for example, an automobile, allowing the mechanical locking and unlocking of the reverse gear position is well known. Additionally, it has a second, separate component that can detect when said reverse gear is in gear, with both components being connected to a calculator.

The above arrangement has the disadvantage of increasing the assembly time of such two components inside the vehicle and at the same time doubling the number of electrical connections as well as the housings to accommodate such connections and components. As a result, this implies a higher manufacturing and assembly cost, so there is a need to find a solution.

### DESCRIPTION OF THE INVENTION

The invention herein has been developed with the aim of providing a locking/unlocking device that resolves the aforementioned drawbacks, providing, in addition, other additional advantages that will become apparent from the description appended hereinafter.

It is therefore an object of the present invention to provide a locking/unlocking device, specifically for locking and unlocking the reverse gear of the gearbox of a vehicle, being of the type that comprises a housing provided on the inside with a fixed core provided with a coil and a mobile core triggered by the activation of the coil and attached to a computer by electrical connection means and a cam that is part of the gearbox and is characterized in that it comprises a reverse gear position detector mechanism that is associated to the mobile core, said detector mechanism being provided with a stationary hall sensor and electromagnet on the inside of the housing that operate via the presence of a metallic member arranged in the mobile core, such that depending on the position of the mobile core in relation to the fixed core, the hall sensor sends a signal to the computer to activate or lock the reverse gear condition.

Thanks to these characteristics, as the device is provided with a dual functionality, as mentioned previously, the assembly time of a detection and locking/unlocking system in a vehicle, as well as the number of components, in particular, in respect of electrical connectors, is reduced. As a result, the likelihood of vehicle breakdown is also reduced.

According to one aspect of the invention, the mobile core comprises a main body axially sliding through a longitudinal cavity located inside the housing, inside of which a moveable rod is coupled in relation to said main body, having been provided elastic means attached between the main body and the rod and elastic means attached between the rod and the metallic member.

Preferably, the metallic member consists of a substantially cylindrical-shaped body coupled in a fixed manner to a support that rests on the main body, whose support is coupled to the elastic means that attaches the main body and the rod and the elastic means that attaches the rod and the metallic member.

In a preferred embodiment of the invention, the electrical connection means comprises a printed circuit board or a flex circuit from which terminals which can be coupled to an external connector linked to a coil protrude, the hall sensor being joined to the cantilevered printed circuit board and electrically connected to terminals linked to said hall sensor, while the circuit board rests on a support member. It will be apparent to an expert that an overmoulded circuit can be used instead of a printed circuit.

Advantageously, the support member comprises coupling means for attachment to the printed circuit, such as, for example, several nubs that protrude from the support member that are inserted into orifices made in the printed circuit board.

The substantially cylindrical-shaped body has a protrusion with a harpoon-shaped end piece that is inserted into a clearance orifice made in the support, being a quick-coupling assembly and simple construction connection.

According to another aspect of the invention, the device may comprise an inner casing that surrounds the mobile core superiorly and laterally, said casing being fixed to the housing and the housing base having several tabs that retain the aforementioned casing.

Advantageously, a gasket located in a cavity defined between the inner wall of the housing and the casing is also provided.

Additionally, it comprises a protective cap coupled to the housing that has an orifice through which the terminals protrude, such that it protects the components located inside the housing from dust and other dirt particles. In addition, sealing means between the housing and the protective cap, such as an O-ring housed in peripheral housing located on the inner wall of the housing, is provided.

Other characteristics and advantages of the locking/unlocking device object of the present invention will become apparent from the description of a preferred, although not exclusive, embodiment, that is illustrated by way of non-limiting example in the drawings appended, in which:

### BRIEF DESCRIPTION OF THE DRAWINGS

FIG. 1.—Perspective view of the locking/unlocking device in accordance with the present invention; and

FIG. 2.—Exploded perspective view of the main elements that form part of the locking/unlocking device.

FIG. 3.—Section view of the locking/unlocking device in a condition wherein the reverse gear of a gearbox is locked;

FIG. 4.—Section view of the locking/unlocking device in a condition wherein the gear is released; and

FIG. 5.—Section view of the locking/unlocking device in a condition of detecting the reverse gear.

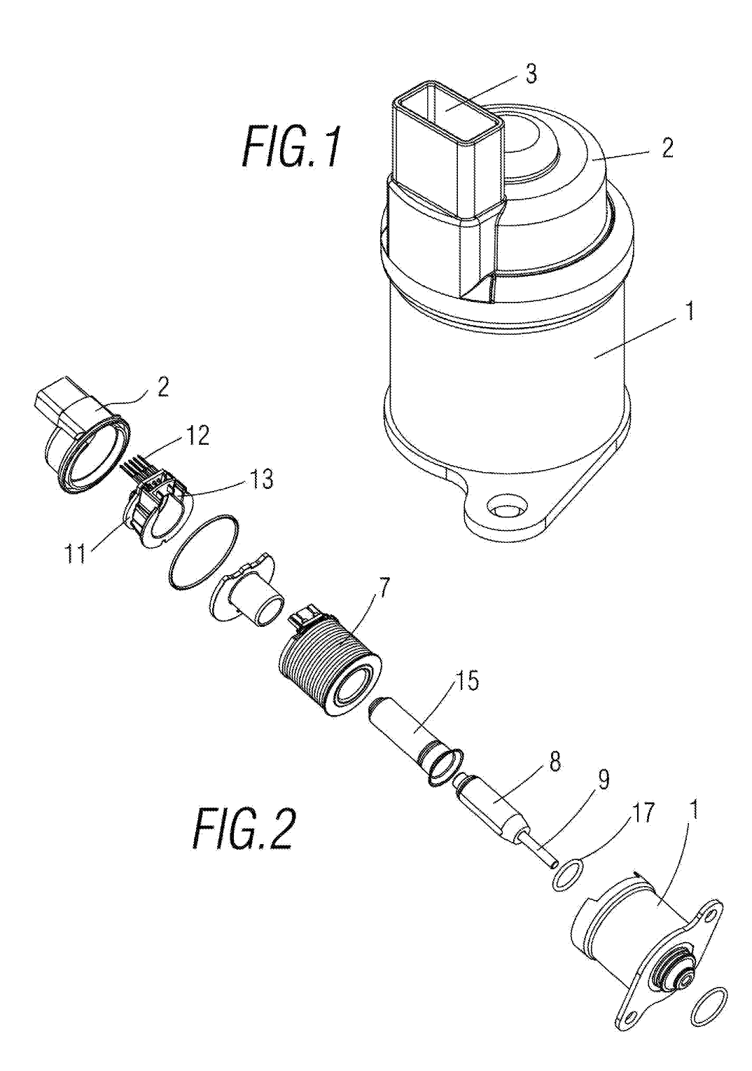

### DESCRIPTION OF A PREFERRED EMBODIMENT

As shown in the figures, an embodiment of the locking/unlocking device is specifically for locking and unlocking the reverse gear of the gearbox of a vehicle that comprises a housing 1 made from a mouldable plastic material with a substantially cylindrical shape, which is provided on the inside with a fixed core provided with a coil 7 and a mobile core, described in greater detail hereinafter, which is triggered by the activation of the coil 7 and attached to a computer by electrical connection means and a cam (not shown) that is part of the gearbox of the vehicle in which the device is installed.

The housing 1 is coupled to a protective cap 2 that has an orifice 3 through which terminals that form part of the electrical connection protrude, in whose connection area a gasket 18 is provided between them. It will be apparent to anyone skilled in the art that a silicone cord can be used instead of a gasket.

Said device comprises a reverse gear position detector mechanism that is associated to the mobile core inside the aforementioned housing 1, said detector mechanism being provided with a cantilevered hall sensor 4 and an electromagnet 5, both the hall sensor 4 and the electromagnet 5 being stationary inside the housing 1 that operate via the presence of a metallic member 6 arranged in the mobile core, such that depending on the position of the mobile core in relation to the fixed core, the hall sensor 4 sends a signal to the computer (located on the exterior) to activate or lock the reverse gear condition due to the variation of the magnetic field of the electromagnet 5 caused by the approximation or distancing of the metallic member 6.

Referring in particular to the mobile core it comprises a main body 8 elongated axially sliding through a longitudinal cavity located inside the housing 1 inside of which a rod 9 is coupled, also made from plastic material, axially moveable in relation to said main body 8, with a maximum stroke of 3.8 mm.

For the movement of the rod 9, directly or indirectly, elastic means has been provided, in particular, a helicoidal stainless steel spring 19, attached between the main body 8 and the rod 9 and elastic means, in particular, a helicoidal stainless steel spring 20, attached between the rod 9 and the metallic member 6.

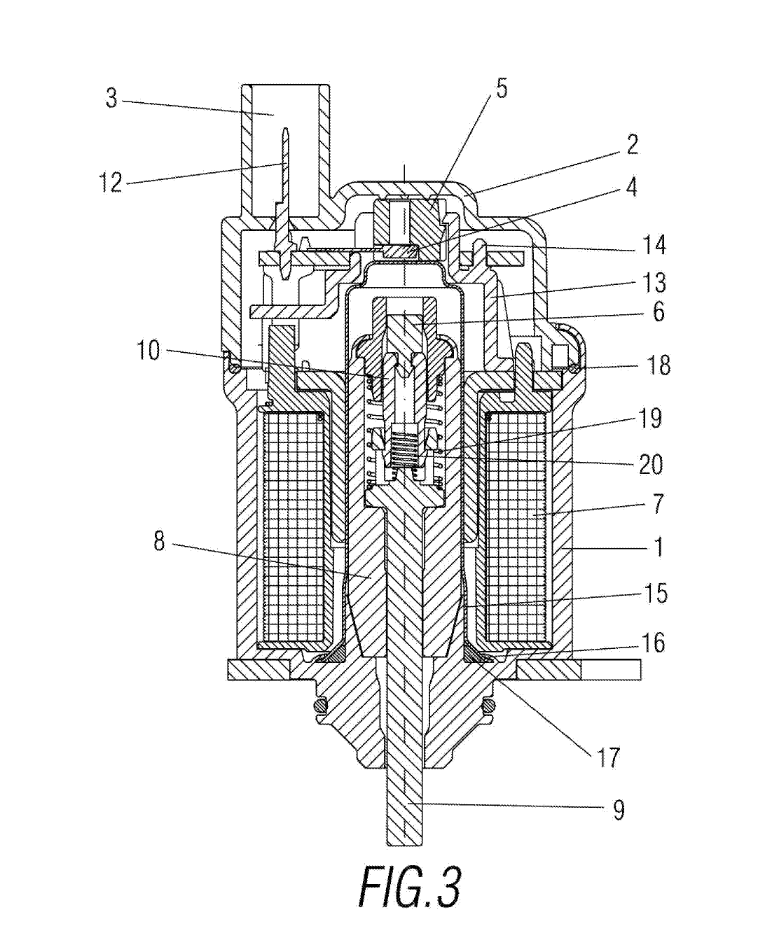

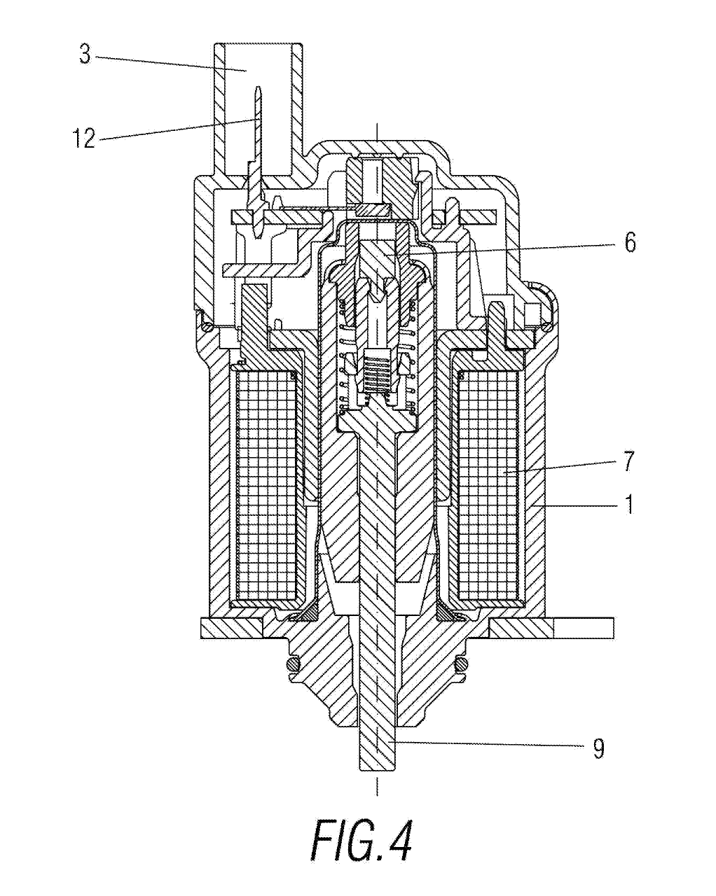

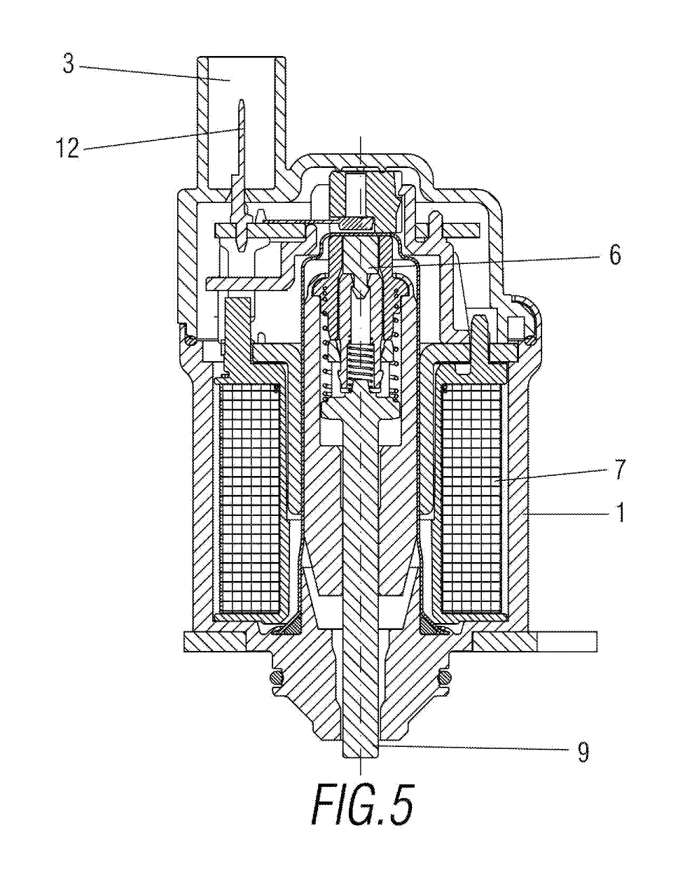

Thus, depending on the position of the rod 9, the reverse gear of the gearbox will be in gear or not, where the different positions can be seen in FIGS. 3 to 5 and, therefore, the stroke the rod 9 performs.

As can be seen in FIGS. 3 to 5, the metallic member 6 above consists of a body that has a substantially cylindrical shape that has a protrusion with a harpoon-shaped end piece, such that it can be inserted into a clearance orifice made in a support 10.

Returning, once again, to the electrical connection means, it comprises a printed circuit board 11 from which terminals 12 protrude, which can be coupled to an external connector linked to a coil 7, the hall sensor 4 being joined to the cantilevered printed circuit board 11 and electrically connected to terminals linked to said hall sensor 4, while the printed circuit board 11 rests on a support member 13.

To secure the support member to the printed circuit board 11 coupling means has been provided consisting of nubs 14 that protrude from the support member 13 that are inserted into orifices made in the printed circuit board 11.

Inside the housing 1 a substantially bell-shaped inner casing 15 is also provided(see FIG. 2) and with reduced thickness surrounding the mobile core, which is secured to the housing 1 by means of retaining tabs 16 that protrudes retaining the aforementioned inner casing 15. To ensure good sealing of the components housed inside the inner casing 15 a gasket 17 located next to the retaining tabs 16 is provided.

The details, shapes and dimensions and other accessory elements as well as the materials used in the manufacture of the locking/unlocking device of the invention may be conveniently replaced by others which are technically equivalent and do not depart from the essential nature of the invention or from the scope defined by the claims provided hereinafter.

1. A locking/unlocking device, specifically for locking and unlocking the reverse gear of the gearbox of a vehicle comprising a housing provided on the inside with a fixed core provided with a coil and a mobile core triggered by the activation of the coil and attached to a computer by electrical connection means and a cam that is part of the gearbox, wherein a reverse gear position detector mechanism is associated to the mobile core, said detector mechanism being provided with a stationary hall sensor and electromagnet on the inside of the housing that operate via the presence of a metallic member arranged in the mobile core, such that depending on the position of the mobile core in relation to the fixed core, the hall sensor sends a signal to the computer to activate or lock the reverse gear condition.

2. A locking/unlocking device according to claim 1, wherein the mobile core comprises a main body axially sliding through a longitudinal cavity located inside the housing, inside of which a moveable rod is coupled in relation to said main body, having been provided elastic structure attached between the main body and the rod and elastic structure attached between the rod and the metallic member.

3. A locking/unlocking device according to claim 2, wherein the metallic member is comprised of a substantially cylindrical-shaped body coupled in a fixed manner to a support that rests on the main body, whose support is coupled to the elastic structure that attaches the main body and the rod and the elastic structure that attaches the rod and the metallic member.

4. A locking/unlocking device according to claim 2, wherein the elastic structure is comprised of helicoidal springs.

5. A locking/unlocking device according to claim 1, wherein the electrical connection comprises a printed circuit board or flex circuit from which terminals that can be coupled to an external connector linked to a coil protrude, the hall sensor being joined to the cantilevered printed circuit board and electrically connected to terminals linked to said hall sensor, while the printed circuit board rests on a support member.

6. A locking/unlocking device according to claim 5, wherein the support member comprises a coupling for attachment to the printed circuit board or flex circuit.

7. A locking/unlocking device according to claim 6, wherein said coupling is comprised of nubs that protrudes from the support member that are inserted into orifices made in the printed circuit board.

8. A locking/unlocking device according to claim 3, wherein the substantially cylindrical-shaped body has a protrusion with a harpoon-shaped end piece that is inserted into a clearance orifice made in the support.

9. A locking/unlocking device according to claim 1, wherein it comprises a substantially bell-shaped inner casing that surrounds the mobile core superiorly and laterally, said casing being fixed to the housing.

10. A locking/unlocking device according to claim 9, wherein the inner face of the base of said housing has retaining tabs that protrude, such that they retain the aforementioned inner casing.

11. A locking/unlocking device according to claim 9, wherein a gasket located in a cavity defined between the inner wall of the housing and the casing is provided.

12. A locking/unlocking device according to claim 1, wherein it comprises a protective cap coupled to the housing that has an orifice through which the terminals protrude.

13. A locking/unlocking device according to claim 12, wherein a seal is disposed between the housing and the protective cap.

14. A locking/unlocking device according to claim 13, wherein said seal comprises an O-ring housed in a peripheral housing located on the inner wall of the housing.
